(19) United States
(12) Patent Application Publication
(10) Pub. No.: US 2026/0168410 A1
(43) Pub. Date: Jun. 18, 2026

(54) RESONATOR FOR TURBINE ENGINES

(71) Applicant: Solar Turbines Incorporated, San Diego, CA (US)

(72) Inventors: Vu M. PHI, Oceanside, CA (US); Ricardo ALEMAN, San Diego, CA (US)

(73) Assignee: Solar Turbines Incorporated, San Diego, CA (US)

(21) Appl. No.: 18/982,335

(22) Filed: Dec. 16, 2024

(51) Int. Cl. F01D 25/30; B33Y 10/00; B33Y 80/00

(52) U.S. Cl. CPC F01D 25/30; B33Y 10/00; B33Y 80/00; F05D 2230/31; F05D 2240/35; F05D 2260/96

(57) ABSTRACT

A resonator and related methods are described herein. The resonator includes a body having a front surface and a rear surface. The body defines a first chamber and a second chamber. The first chamber is configured such that fluid within the first chamber resonates at a first frequency. The second chamber is configured such that fluid within the second chamber resonates at a second frequency that is different from the first frequency. The body further defines an inlet hole and an outlet hole. The inlet hole extends from the front surface toward the rear surface to one of the first chamber and the second chamber. The outlet hole extends from the rear surface towards the front surface to one of the first chamber and the second chamber. The body is configured to be connected to a dome or liner of a combustion system.

### U.S. GOVERNMENT RIGHTS

This invention was made with Government support under Contract No. DE-FE0032106 awarded by U.S. Department of Energy. The government has certain rights in the invention.

### TECHNICAL FIELD

The present disclosure relates generally to turbine engines, and more particularly to resonators for a turbine engine.

### BACKGROUND

Gas turbine engines produce power by extracting energy from hot gases produced by combustion of a fuel and air mixture. Combustion of hydrocarbon fuels produce pollutants, such as NOₓ. Some techniques (lean premixed combustion, etc.) have been developed to reduce NOₓ. However, such techniques can cause combustion instability, such as thermo-acoustic oscillations (also referred to herein as “combustion oscillations” or “combustion induced oscillations”) in the combustion chamber. These oscillations occur as a result of coupling of the heat release and pressure waves and can produce resonance at the natural frequencies of the combustion chamber. These oscillations may result in mechanical and thermal fatigue of engine components or cause other adverse effects on the engine. Therefore, it is desirable to reduce the amplitude of these combustion induced oscillations. Several approaches have been developed to reduce the magnitude of thermo-acoustic oscillations in gas turbine engines. These approaches may be broadly classified as active and passive approaches. Active approaches use an external feedback loop to detect the amplitude of the oscillations, and make a real-time operational change (such as, for example, fueling change) to dampen the oscillations if the detected amplitude exceeds a predetermined value. Passive approaches include increasing acoustical attenuation by design modifications to the gas turbine engine. While active approaches may dampen oscillations in real-time, the cost and complexity of implementing an active approaches may be significant. Further, passive approaches may be difficult to implement, especially when it is desirable to damp multiple resonance frequencies.

European Patent Application Publication No. EP 4198395 A1, published on June 21, 2023 (“the ’395 publication”), describes a turbine engine comprising a combustor having a combustor liner and a dome plate. The dome plate of the ’395 publication includes a set of resonator cavities proximate the dome plate and fluidly coupled to the set of apertures. The set of resonator cavities forms an acoustic resonator within the combustor. Forming a resonator within the combustor may increase the difficulty, cost, and time of repairs, as well as increase the need to perform maintenance, replacement, and/or make modifications to the system.

The present disclosure may solve one or more of the problems set forth above and/or other problems in the art. The scope of the current disclosure, however, is not limited by the ability to solve any specific problem.

### SUMMARY

Each of the aspects disclosed herein may include one or more features described in connection with any of the other disclosed aspects.

Aspects of the present disclosure include a resonator for a combustion system comprising a body having a front surface and a rear surface. The body defines a first chamber and a second chamber. The first chamber is configured such that fluid within the first chamber resonates at a first frequency. The second chamber is configured such that fluid within the second chamber resonates at a second frequency that is different from the first frequency. The body further defines an inlet hole extending from the front surface towards the rear surface to one of the first chamber and the second chamber. The body is configured to be connected to a dome or liner of a combustion system.

Aspects of the present disclosure may be directed to a combustor system comprising a combustor defining a volume, and a plurality of resonators. Each of the resonators comprises a body having a front end and rear end. The body of each resonator defining a plurality of chambers. Each chamber of the plurality of chambers is configured so that fluid within the respective chamber resonates at different frequencies. The body of each resonator further defines a plurality of inlet holes and a plurality of outlet holes. The plurality of inlet holes extend from the front end and is fluidly connected to one chamber of the plurality of chamber. The plurality of outlet holes extend from the rear end and is fluidly connected to one chamber of the plurality of chambers. The plurality of resonators extend outside of the volume of the combustor.

Aspects of the present disclosure may be directed to a method for manufacturing a resonator via an additive manufacturing process. The method comprises: forming a first plurality of layers. The first plurality of layers includes a plurality of inlet holes. The method further comprises: forming a second plurality of layers. The second plurality of layers include a plurality of chambers. Each chamber of the plurality of chambers is in fluid communication with an inlet hole of the plurality of inlet holes. The method further comprises: forming a third plurality of layers. The third plurality of layers includes a plurality of outlet holes. Each chamber of the plurality of chambers is in fluid communication with an outlet hole of the plurality of outlet holes.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective cutaway view of an exemplary turbine engine.

FIG. 2 is a cross-sectional view of a dome plate of the turbine engine of FIG. 1 with a plurality of resonators.

FIG. 3A-3D depict a side view of a resonator (FIG. 3A), a cross-sectional side view of the resonator (FIG. 3B), a front view (FIG. 3C) and a top view (FIG. 3D) of the resonator with chambers and holes of the resonator depicted in dashed lines.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

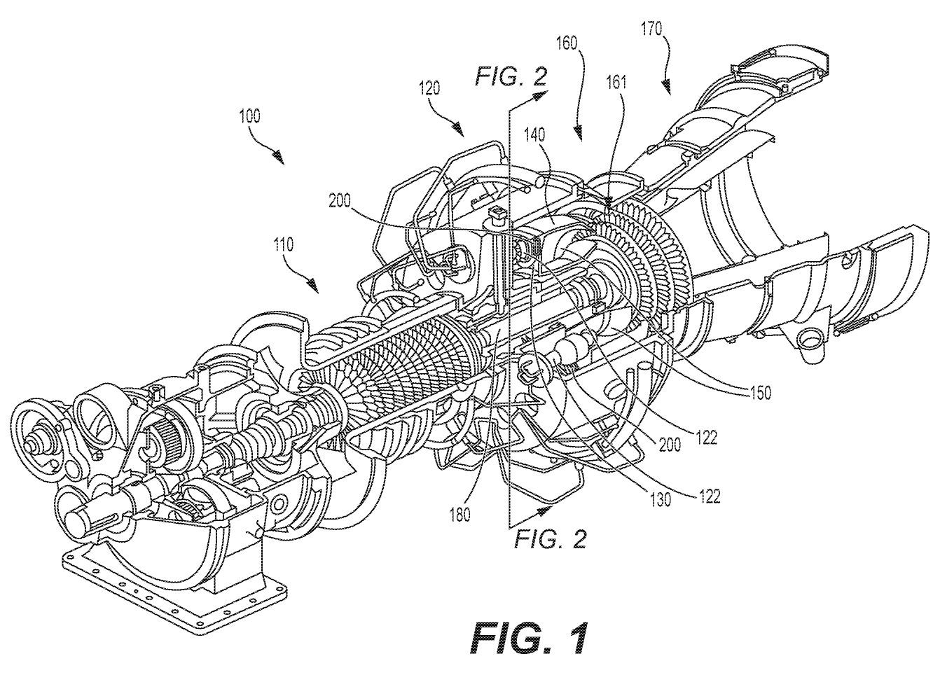

FIG. 1 depicts an exemplary turbine engine 100 that may include, among other systems, a compressor 110, a combustor 120, a turbine assembly 160, and an exhaust 170. Engine 100 includes a front, proximal end (proximate compressor 110) and a rear, distal end (proximate exhaust 170). For clarity, certain portions of the turbine engine 100 are omitted. Compressed air from compressor 110 is mixed with a fuel in one or more fuel injectors of a plurality of fuel injectors 122 coupled to combustor 120 to form a fuel-air mixture. The fuel-air mixture is directed to a combustion chamber 150 of combustor 120 and ignited to produce combustion gases having high pressures and temperatures. The combustion gases are directed to turbines 161 of turbine assembly 160 to drive a shaft 180 of the turbine engine 100. Shaft 180 may define a central longitudinal axis of the turbine engine 100. According to aspects of this disclosure, turbine engine 100 may be configured to combust hydrogen (e.g., the fuel in the fuel injector is hydrogen gas, liquid, or fluid) or other renewable gases. According to some aspects of this disclosure, turbine engine 100 may be a gas turbine engine configured to combust hydrocarbon chains.

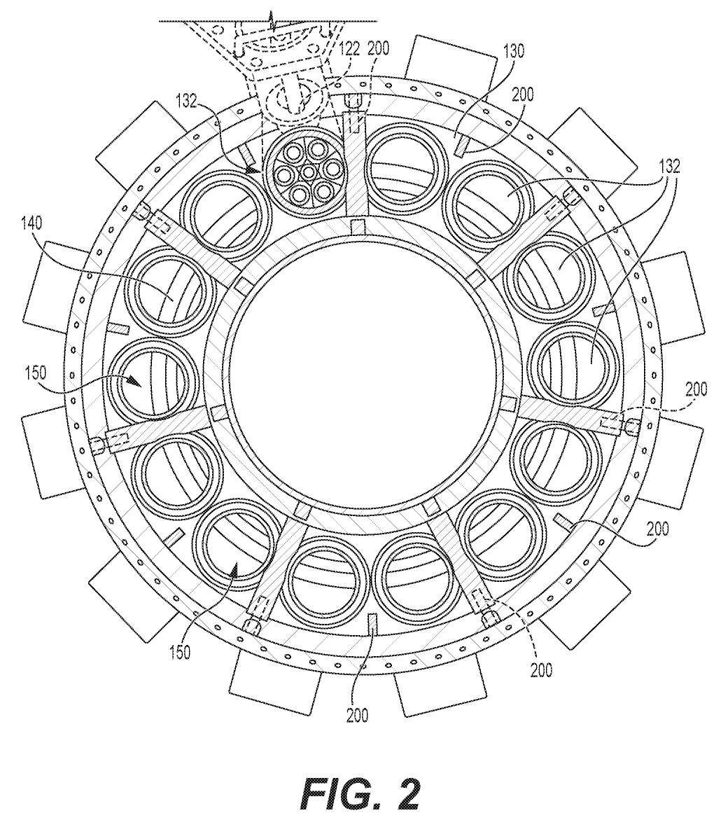

FIG. 2 depicts a cross-sectional view of turbine engine 100 viewed according to the arrows shown in FIG. 1. FIG. 2 depicts combustion system or combustor 120, and, in particular, depicts a front end or portion of a dome 130 of combustor 120. Combustor 120 may further include a liner 140. The dome 130 and liner 140 of combustor 120 may define a combustion chamber 150. According to some aspects of the present disclosure, dome 130 may be a component or portion of liner 140. The fuel-air mixture formed with fuel injected by plurality of fuel injectors 122 and compressed air from compressor 110 is combusted or ignited within combustion chamber 150. As the fuel-air mixture is combusted within combustion chamber 150, the compressed air of the mixture may increase in volume and drive the turbines 161 of turbine assembly 160.

As depicted in FIG. 2, dome 130 may include a plurality of apertures 132. Each aperture 132 may extend from a front end of dome 130 to a rear end of dome 130. Further, each aperture 132 may be sized and shaped to receive a portion of one fuel injector 122 of the plurality of fuel injectors. For example, each aperture 132 may be configured to receive a rear portion or rear end of one fuel injector 122.

Dome 130 may include a circular cross-section or a circular perimeter when viewed from the arrows shown in FIG. 1, however, this is exemplary and dome 130 may include any suitable cross-section shape or perimeter. Dome 130 may include a dome-shape or a half torus geometry; however, this is also exemplary and dome 130 may include any suitable shape. Dome 130 may be coaxial or approximately coaxial with the central longitudinal axis of turbine engine 100. The plurality of apertures 132 may be circumferentially arranged along dome 130 relative to the central longitudinal axis. In the exemplary embodiment shown in FIG. 2, dome 130 may include fourteen apertures 132 and one fuel injector 122 may be coupled to and/or received in each aperture 132.

As shown in FIGS. 1-2, a plurality of resonators 200 may be positioned between adjacent apertures 132 of the plurality of apertures. For example, the plurality of resonators 200 may include fourteen resonators 200. The fourteen resonators 200 may be circumferentially arranged around the dome 130 relative to central longitudinal axis of the turbine engine 100. Each resonator 200 may be positioned at a different angle around the central longitudinal axis. Adjacent resonators 200 of the fourteen resonators 200 may be evenly spaced around the circumference of the dome 130. Further, an axis of each resonator 200 may be perpendicular to a central longitudinal axis of the turbine engine 100. According to some aspects, the plurality of resonators 200 may include any number of resonators 200 such as six, ten, or twenty. Features of resonators 200 are discussed in detail below. As shown in FIG. 1, resonator 200 may be fixedly or removably coupled to the front end of dome 130. Dome 130 may include a plurality of through holes extending from the front end of dome 130 to the rear end of dome 130. Each of these through holes may be configured to receive a portion (e.g., a rear end or rear portion) of at least one resonator 200. In an example, a portion of each resonator 200 may be received by one of the plurality of through holes and welded to the respective through hole and dome 130. After resonator 200 is received within a through hole of dome 130, one or more side surfaces (e.g., side surface 202c) may be welded to dome 130. Resonators 200 may facilitate the transfer of gases (e.g., compressed air) from a volume in front of dome 130 to a volume to the rear of dome 130 (e.g., combustion chamber 150). Each resonator 200 may be formed via additive manufacturing to be compatible with a turbine engine such that each resonator dampens two or more frequencies that tend to cause combustion oscillations in the turbine engine. For example, each resonator 200 may be formed via additive manufacturing to be compatible with turbine engine 100 and to be configured to dampen two or more combustion oscillation frequencies of turbine engine 100.

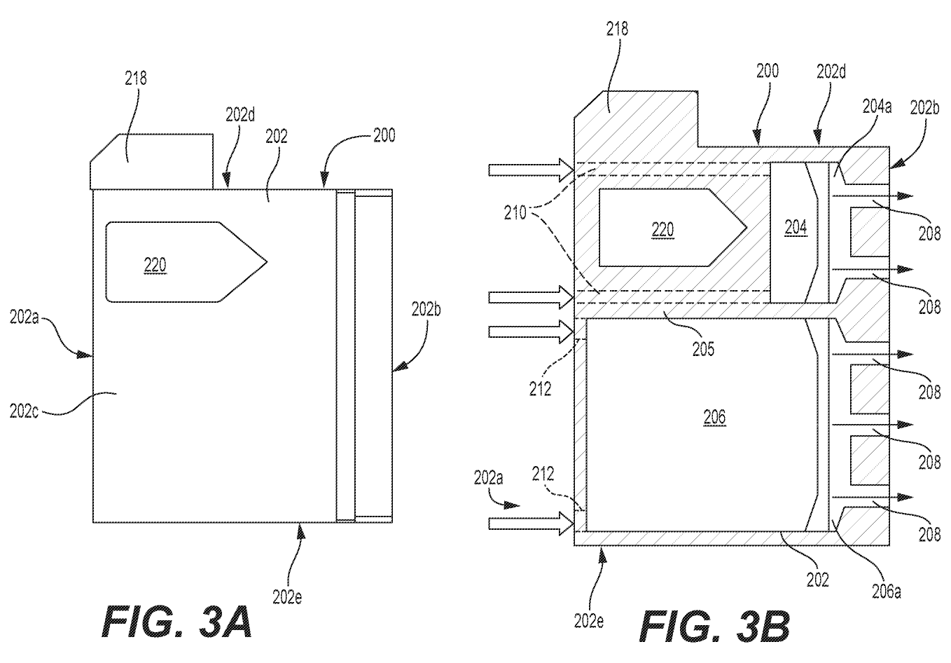

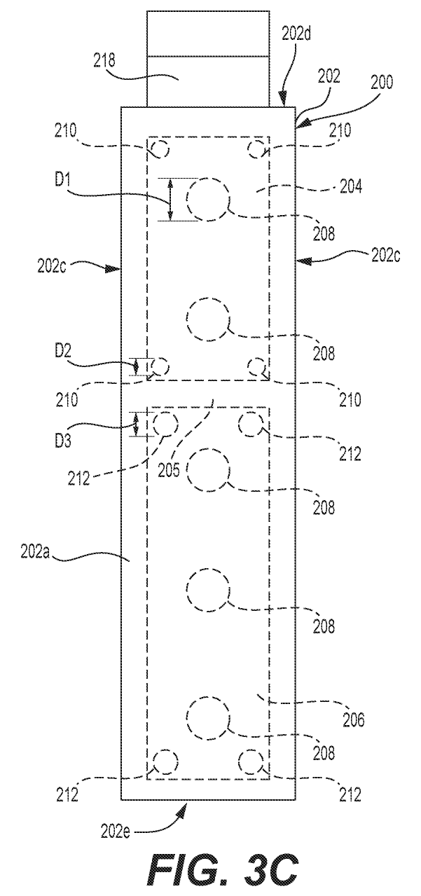

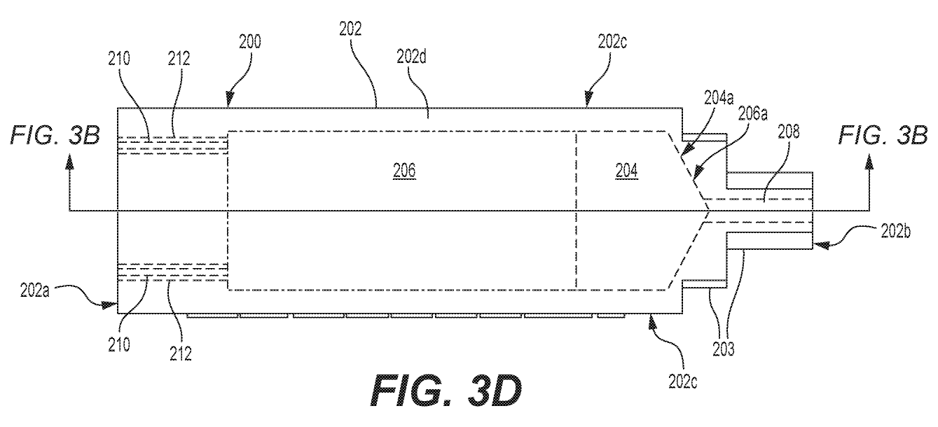

FIGS. 3A-3D are views showing an exemplary resonator 200. As shown, resonator 200 includes a body 202 that may include a generally rectangular prism-shape; however, this is merely exemplary, and body 202 may include any shape such as a cuboid, a cylinder, a dome, etc. The body 202 of resonator 200 may include a front surface 202a, a rear surface 202b, and two side surfaces 202c positioned between the front surface 202a and the rear surface 202b. A surface area of the front surface 202a may be greater than a surface area of the rear surface. A rear portion of body 202, including rear surface 202b, may include one or more shelves or steps 203, each having a reduced depth or thickness compared to the remainder of body 202. The reduced depth(s) or thickness(es) of the shelves 203 may reduce the size of the through hole of dome 130 necessary to receive the rear portion of resonator 200. One or more corners of shelves 203 may be beveled, chamfered, or curved. The reduced depth or thickness of the rear portion of body 202 may help to minimize the amount of surface area of body 202 exposed to combustion gases produced within combustor 150. Further, body 202 may include a top surface 202d including an optional boss 218, and a bottom surface 202e. Body 202 may include a through hole 220 extending from the first side surface 202c to the second side surface 202c.

FIGS. 3A-3B depict a side view (FIG. 3A) and a cross-sectional side view of resonator 200 (FIG. 3B) taken along the cross section line shown in FIG. 3D. Body 202 of resonator 200 may include a plurality of chambers and a plurality of through holes such that gases may travel through the resonator 200 from the front surface 202b (which may be secured, e.g., in front of dome 130) to the rear surface 202c (which may be secured, e.g., within combustion chamber 150). Each chamber may define a volume and may be configured such that fluids (e.g., compressed air) therein to resonate at a different frequency compared to the fluids within other chambers. For example, body 202 may define a first chamber 204 and a second chamber 206. In the illustrated example, chamber 204 and chamber 206 are positioned side-by-side with first chamber 204 being located closer to top surface 202d. As shown in FIG. 3B, a top surface (e.g., interior surface) of chamber 204 may be adjacent to top surface 202d of body 202, a bottom surface of chamber 204 may be adjacent to a top surface of chamber 206, and a bottom surface of chamber 206 may be adjacent to bottom surface 202e. For example, a wall 205 of body 202 positioned between chambers 204, 206 may separate chambers 204, 206 from one another. Wall 205 may be parallel or approximately parallel to the central longitudinal axis and may define the bottom surface of chamber 204 and the top surface of chamber 206. In embodiments with three or more chambers, a corresponding number of walls 205 may be included. Chamber 204 may define a first volume and chamber 206 may define a second volume that is greater than the first volume of chamber 204. However, this is exemplary, and according to some aspects of the present disclosure, one or more chambers of the plurality of chambers define the same volume or a greater or lesser volume relative to other chambers of the plurality of chambers. For example, the first volume may be greater than or equal to the second volume. In another example, according to aspects of the present disclosure, where the plurality of chambers includes three or more chambers, two chambers may include two chambers defining the same volume and one chamber defining a volume larger than the other chambers.

Referring to FIG. 3B, body 202 may define a plurality of outlet holes formed by individual outlet holes 208 (e.g., through holes) extending from the rear surface 202b to one of chambers 204, 206. Outlet holes 208 may facilitate fluid communication between combustion chamber 150 and respective chamber 204, 206 such that fluids within chambers 204, 206 may pass through outlet holes 208 into combustion chamber 150. Each of outlet holes 208 may include a diameter, D1 (FIG. 3C). The diameter D1 of each of outlet holes 208 may be the same diameter. According to some embodiments, the outlet holes 208 connected to chamber 204 have a different diameter from the diameter of the outlet holes 208 connected to chamber 206. As depicted in FIG. 3B, a rear surface (e.g., interior surface) of each of chambers 204, 206 may include ones or more angled surfaces or inclines 204a, 206a, respectively, configured to direct or guide fluid flow (e.g., air flow) toward outlet holes 208 of respective chambers 204, 206.

One or more outlet holes 208 may extend from rear surface 202b to first chamber 204 and one or more outlet holes 208 may extend from rear surface 202b to second chamber 206. The number of outlet holes 208 connected to first chamber 204 may be different from the number of outlet holes 208 connected to second chamber 206. For example, as shown in FIG. 3B, three outlet holes 208 may be connected to second chamber 206 and two outlet holes 208 may be connected to first chamber 204. However, this is merely exemplary and chamber 204, 206 may be connected to any number of outlet holes 208. According to some embodiments of the present disclosure, the number of outlet holes 208 connected to each chamber (such as chambers 204, 206) may be dependent on the volume of the chamber. For example, chambers with larger volumes may be connected to more outlet holes 208 than chambers with lesser volumes.

With reference to FIGS. 3B-3D, body 202 of resonator 200 may define a plurality of inlet holes (e.g., through holes) extending from the front surface 202a to one of chambers 204, 206. The plurality of inlet holes may facilitate positive airflow within resonator 200 so that compressed air moves from the front surface 202a to the rear surface 202b and into combustion chamber 150. Moreover, the positive air flow may prevent hot combustion gases generated within combustion chamber 150 from moving from rear surface 202b to front surface 202a. For example, body 202 may define a plurality of first inlet holes formed by individual first inlet holes 210 extending from front surface 202a to chamber 204 and a plurality of second inlet holes formed by individual second inlet holes 212 extending from front surface 202a to chamber 206. Body 202 may define an equal number of first inlet holes 210 and second inlet holes 212. In alternative embodiments, body 202 may define a different number of first inlet holes 210 and second inlet holes 212.

As shown in FIG. 3C, each first inlet hole 210 may define a diameter D2 and each of second inlet hole 212 may define a diameter D3. According to some aspects of the present disclosure, diameter D2 may be the same or different diameter from diameter D3. Diameter D1 of outlet holes 208 may be greater than one or more of diameters D2, D3. For example, D1 may be greater than diameters D2 and D3. The diameter D2 of each first inlet hole 210 may be the same diameter. Diameter D2 may be about 25% to about 50% the diameter of diameter D1. For example, diameter D2 may be about 33% of the diameter of diameter D1. Further, each second inlet hole 212 may include a diameter, D3. The diameter D3 of each second inlet hole 212 may be the same diameter. Diameter D3 may be about 33% to about 66% of the diameter D1. For example, diameter D3 may be about 50% of the diameter of diameter D1.

FIGS. 3C-3D depict a front view (FIG. 3C) and a top view (FIG. 3D) of resonator 200 with chambers 204, 206, inlet holes 210, 212, and outlet holes 208 drawn in dashed lines. Boss 212 is omitted from FIG. 3D. Inlet holes 210, 212 and/or outlet holes 208 may extend parallel, or approximately parallel, with the central longitudinal axis of turbine engine 100 and/or a common axis. As shown in FIG. 3C, a front surface (e.g., interior surface) of each of chambers 204, 206 may define a perimeter. At least one inlet hole 210, 212 (e.g., an opening of the hole) may be positioned in each corner of the perimeter of respective chamber 204, 206. For example, the front surface of first chamber 204 may define a rectangular perimeter and body 202 may define four inlet holes 210 with one inlet hole 210 in each corner of the rectangular perimeter. Similarly, the front surface of second chamber 206 may include a rectangular perimeter and body 202 may define four inlet holes 212 with one inlet hole 210 in each corner of the rectangular perimeter. In some embodiments, one or more inlet holes 210, 212 may be omitted such that not every corner of the perimeter of respective chamber 204, 206 includes an inlet hole. Liquids (e.g., water) may accumulate within chambers of resonator 200 during non-operating periods of turbine engine 100. Alternatively, liquids may accumulate within chambers of resonator 200 during operating periods of turbine engine 100 as a by-product of combustion reactions. Removal of these liquids via inlet holes 210, 212 may prevent blockages of inlet holes 210, 212 preventing gas transfer through holes 210, 212 and increase available volume within the respective chamber for receiving gases from inlet holes 210, 212. Although the perimeter of the front surfaces of chambers 204, 206 are described as including a rectangular perimeter, it should be understood that the surfaces of chambers 204, 206 are not limited to rectangular shapes and may be any shape. In alternative embodiments where the front surfaces of chambers 204, 206 define a perimeter without corners (e.g., circles, ovals, egg-like shapes, etc.) inlet holes 210, 212 may be positioned along the respective perimeter such that inlet holes 210, 212 are evenly spaced or equidistant from one another.

The position of inlet holes 210, 212 at each corner of the respective perimeter may allow liquids within the chambers 204, 206 to flow from the chambers 204, 206 through one or more of inlet holes 210, 212 regardless of the orientation of the resonators 200 relative to the central longitudinal axis of turbine engine 100 or dome 130. In the example where the plurality of resonators 200 includes fourteen resonators 200, as discussed above, an axis of each resonator 200 of the fourteen resonators 200 may be perpendicular to central longitudinal axis of the turbine engine 100. Moreover, each resonator 200 may be evenly distributed about a circumference of the dome 130. Each resonator 200 may be positioned so one of the top surface 202d and bottom surface 202e is nearer the central longitudinal axis than the other of the top surface 202d and the bottom surface 202e. Accordingly, one or more of the inlet holes 210, 212 of each may help to drain liquids within chambers 204, 206 of one or more resonators 200 of the fourteen resonators 200. For example, referring to FIG. 2, where resonator 200 is positioned at a 12’o clock position, liquid within chambers 204, 206 may drain via one or more respective inlet holes 210, 212 positioned nearest the bottom surface 202e. In another example, where resonator 200 is positioned at a 3’o clock position, liquid within chambers 204, 206 may drain via one or more respective inlet holes 210, 212 positioned nearest side surface 202c. In an example, where resonator 200 is positioned at a 4’o clock position, liquid within chambers 204, 206 may drain via one or more respective inlet holes 210, 212 positioned in a corner nearest top surface 202d and side surface 202c.

Fluid (e.g., compressed air) within each chamber of resonator 200 may be configured to resonate at a unique or different frequency (e.g., a resonance frequency) as fluid (flows from a volume or space in front of dome 130 through the chamber (e.g., chambers 204, 206) and corresponding inlet (e.g., first inlet holes 210 or second inlet holes 212) and corresponding outlet holes (e.g., outlet holes 208). Further, the chambers of resonator 200 may each be configured such that fluid within the chamber resonates at a natural frequency of the turbine engine. In an example, as fluid flows through inlet holes 210, chamber 204, and respective outlet holes 208, chamber 204 may be configured such that fluid within resonates at a first frequency. Similarly, as fluid flows through inlet holes 212, chamber 206, and respective outlet holes 208, chamber 206 may be configured such that fluid within resonates at a second frequency that is different from the first frequency. In some examples, the first frequency is higher than the second frequency. In an exemplary embodiment, chamber 206 may be configured such that fluid within resonates at approximately 2000 Hz and chamber 204 may be configured such that fluid within resonates at approximately 4000 Hz.

The resonance frequency of each chamber (e.g., the frequency at which fluid within the chamber resonates) may be dependent on one or more of: dimensions of the chamber (e.g., length, width, depth, angles, etc.), or dimensions of the outlet holes (e.g., length and diameter). Forming the chambers and outlet holes via additive manufacturing may facilitate greater precision of the resonance frequencies of each resonator 200. Each chamber of resonator 200 may be configured so that fluid within resonates at a predetermined frequency. For example, the frequency may be a frequency that damps combustion oscillations within a turbine engine (e.g., engine 100). Frequencies that cause combustion oscillations within a turbine engine may be different depending on the fuel injected by injectors 122 (e.g., such as hydrogen or hydrocarbon chains), dimensions and positions of components of the engine, and other relevant parameters known to those skilled in the art. Accordingly, as combustion oscillation frequencies are different among different turbine engines (e.g., different models of turbine engines and individual engines of the same model), the resonance frequency of each chamber of may be adjusted during manufacture to resonate at a predetermined frequency configured to control, prevent, inhibit, and/or mitigate combustion oscillations of a specific turbine engine. As an example, if a turbine engine experiences combustion oscillations at three frequencies, such as 2000 Hz, 4000 Hz, and 6000 Hz, each resonator 200 may be manufactured to include a first chamber (e.g., chamber 204) configured (e.g., sized, shaped, or other capable of) so that fluid within resonates at 2000 Hz, a second chamber (e.g., chamber 206) configured so that fluid within resonates at 4000 Hz, and a third chamber of the plurality of chambers configured so that fluid within resonates at 6000 Hz.

The present disclosure further includes a method of manufacturing a resonator (e.g., resonator 200) via an additive manufacturing process. For example, resonator 200 and/or body 202 may be formed via an additive manufacturing such as, but not limited to, 3D printing, selective laser sintering (SLS), stereolithography (SLA), fused deposition modeling (FDM), digital light process (DLP), multi jet fusion (MJF), Polyjet, direct metal laser sintering (DMLS), electron beam melting (EBM), and other additive manufacturing processes known by those skilled in the art. It should be understood that portions of the resonator 200 formed via the method discussed below may have any features discussed above. The method may comprise a step of forming a first plurality of layers of the resonator 200. The first plurality of layers may define one or more inlet holes (e.g., inlet holes 210, 212). The first plurality of layers may further include a front end or front surface (e.g., front surface 202a). According to some aspects, the first plurality of layers may define a through hole (e.g., through hole 220) extending perpendicular or approximately perpendicular to the one or more inlet holes. Through hole 220 may extend between one or more inlet holes fluidly connected to one chamber (e.g., chamber 204) and one or more inlet holes fluidly connected (e.g., in fluid communication) to another chamber (e.g., chamber 206).

The method may further comprise a step of forming a second plurality of layers of the resonator 200. The second plurality of layers may define a plurality of chambers (e.g., chambers 204, 206). Each chamber of the plurality of chambers may be fluidly connected to at least one inlet hole of the one or more inlet holes. Adjacent chambers may be separated by a wall (e.g., wall 205) extending therebetween.

The method may comprise a step of forming a third plurality of layers of the resonator 200. The third plurality of layers may include one or more outlet holes (e.g., outlet holes 208). At least one outlet hole of the one or more outlet holes may be fluidly connected to one chamber of the plurality of chambers. Each of outlet hole may include the same diameter. The third plurality of layers may further include the rear portion and/or rear surface (e.g., rear surface 202b) of resonator 200. The method may begin by printing a front surface and then printing front-to-back from the front surface to a rear surface, or vice versa, printing back-to-front by printing the rear surface and printing from the rear surface to the front surface. For example, the front surface may be printed first, followed by the first plurality of layers, the second plurality of layers, the third plurality of layers, and then the rear surface. In some examples, instead of printing front-to-back or back-to-front, the method may begin by printing a top surface (e.g., top surface 202d) and then printing top-to-bottom from the top surface to a bottom surface (e.g., bottom surface 202e), or vice versa. For example, the top surface may be printed first, followed by one or more pluralities of layers defining inlet holes, outlet holes, and chambers, and then the bottom surface.

### Industrial Applicability

The resonators, systems, and methods disclosed herein may be applied to any system that combusts fuel (e.g., such as hydrogen or hydrocarbon fuels), such as a machine having a combustor or combustor system that allows the machine to combust fuels and having other systems or components, such as a turbine and shaft, to convert energy released during combustion into mechanical force. Suitable machines include turbine engines that combust gaseous fuel (e.g., hydrogen) and turbine engines that combust hydrocarbon fuels. During operation of an exemplary turbine engine, a compressor compresses air and delivers the compressed air into a fuel injector. A fuel-air mixture from the fuel injector is directed to a combustor of the turbine engine. The mixture is then ignited and combustion gases are directed to a turbine assembly. Turbine(s) of the turbine assembly extract energy from the combustion gases and drive a shaft of the turbine engine to convert the energy released during combustion to mechanical force (e.g., torque). Fluid (e.g., gas) within a plurality of resonators coupled to the combustor or combustor system may resonate at the same frequencies that cause combustion oscillations within the machine to prevent, mitigate, and/or dampen combustion oscillations.

The disclosed resonators and systems may be configured so that gases within the resonators resonate as gases (e.g., compressed air) flow through the resonator(s) and passing from a volume in front of a dome of the combustor to a volume behind the dome. Turbine engines may generate combustion oscillations at one or more frequencies. Accordingly, the resonator may be configured to include a chamber for each frequency at which the turbine engine generates combustion oscillations. Gases within each chamber of the resonator may resonate at a different frequency. Further, each chamber may be configured so that gases therein resonate at a frequency in which a given turbine engine experiences combustion oscillations. The multiple chambers of the resonator, each configured to resonate at a combustion oscillation frequency of the turbine engine, allow for multiple combustion oscillations frequencies to be controlled simultaneously during operation of the turbine engine. Controlling each combustion oscillation frequency of a system may reduce wear of components of the system, reduce maintenance costs of the system, and reduce downtime of the system.

The disclosed resonators may exhibit increased useful lifespans and performance compared to existing resonators. The inlet holes of the resonators may eliminate liquids within the chambers accumulated during operation of the system to increase the volume of the chamber available to receive compressed air. Further, the inlet holes may facilitate positive air flow through the resonators into the combustion chamber that prevents ingress of hot combustion gases from the combustion chamber into the resonators.

The disclosed resonators may be modular and may be installed into existing and future systems without significant modification of the system. The resonators may be compatible with an individual turbine engine, or a specific model of turbine engine such that fluid (e.g., gas) within the chambers of the resonators resonate at the combustion oscillation frequencies of the relevant system. Current and future systems may utilize alternative types of fuel, such as hydrogen, that may cause combustion oscillations within the system at unknown frequencies. Accordingly, the modularity and the configurable sizes, shapes, and number of the chambers and holes of the resonators may allow for differently configured resonators to be manufactured and be compatible with any system burning any type of fuel. Further, the resonators may be formed via additive manufacturing (e.g., selective layer sintering, 3-D printing, and others), allowing for precise internal geometries and sizes of the chambers and holes that enable the resonator to effectively control combustion oscillations.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A resonator for a combustion system, the resonator comprising:
a body having a front surface and a rear surface, the body defining:
a first chamber, the first chamber configured such that fluid within the first chamber resonates at a first frequency;
a second chamber, the second chamber configured such that fluid within the second chamber resonates at a second frequency that is different from the first frequency;
an inlet hole extending from the front surface towards the rear surface to one of the first chamber and the second chamber; and
an outlet hole extending from the rear surface towards the front surface to one of the first chamber and the second chamber;
wherein the body is configured to be connected to a dome or liner of a combustion system.

2. The resonator of claim 1, wherein the outlet hole is a first outlet hole of a plurality of outlets holes that include the same diameter.

3. The resonator of claim 1, wherein the first chamber includes a front interior surface having a perimeter with one or more corners.

4. The resonator of claim 3, wherein the opening of one of the one or more inlet holes is positioned at each of the one or more corners of the perimeter.

5. The resonator of claim 4, wherein the body defines an equal number of inlet holes and corners of the perimeter.

6. The resonator of claim 4, wherein the perimeter is a rectangle.

7. The resonator of claim 1, wherein the first chamber defines a first volume and the second chamber defines a second volume, wherein the second volume is greater than the first volume.

8. The resonator of claim 7, wherein the inlet hole is in fluid communication with the first chamber including a first diameter and a second inlet hole is in fluid communication with the second chamber, the second inlet hole having a second diameter that is larger than the first diameter.

9. The resonator of claim 8, wherein the first inlet hole and the second inlet hole each have a length, wherein the length of the first inlet hole is greater than the length of the second inlet hole.

10. The resonator of claim 1, wherein a wall of the body separates the first chamber from the second chamber.

11. A combustor system comprising:
a combustor defining a volume; and
a plurality of resonators, each of the resonators comprises a body having a front end and a rear end, the body defining:
a plurality of chambers, each chamber of the plurality of chambers configured so that fluid within the respective chamber resonates at different frequencies,
a plurality of inlet holes extending from the front end and fluidly connected to one chamber of the plurality of chambers, and
a plurality of outlet holes extending from the rear end and is fluidly connected to one chamber of the plurality of chambers;
wherein the plurality of resonators extend outside of the volume.

12. The combustor system of claim 11, wherein the body of each resonator defines a wall separating each chamber from the remaining chambers of the plurality of chambers.

13. The combustor system of claim 11, wherein the frequency of each chamber is a frequency causing combustion oscillations within the combustor system.

14. The combustor system of claim 11, wherein fluids are configured to flow through the resonator from the front end to the rear end of the resonator.

15. The combustor system of claim 11, wherein the plurality of inlet holes are positioned at corners of the plurality of chambers to provide an outlet for liquids within the respective chamber.

16. A method of manufacturing a resonator via additive manufacturing process, the method comprising:
forming first plurality of layers, the first plurality of layers including a plurality of inlet holes;
forming a second plurality of layers, the second plurality of layers including a plurality of chambers, each chamber of the plurality of chambers being in fluid communication with an inlet hole of the plurality of inlet holes; and
forming a third plurality of layers, the third plurality of layers including a plurality of outlet holes, wherein each chamber of the plurality of chambers is in fluid communication with an outlet hole of the plurality of outlet holes.

17. The method of claim 16, wherein the first plurality of layers is positioned at a front end of the resonator and the third plurality of layers is positioned at a rear end of the resonator.

18. The method of claim 16, wherein each chamber of the plurality of chambers is configured so that fluid within the chamber resonates at a frequency different from the fluid within the other chambers of the plurality of chambers.

19. The method of claim 16, wherein the plurality of chambers includes a first chamber and a second chamber, wherein the inlet hole in communication with the first chamber includes a greater diameter than the inlet hole in communication with the second chamber.

20. The method of claim 16, wherein each outlet hole includes the same diameter.
